(19) United States
(12) Patent Application Publication
(10) Pub. No.: US 2002/0126153 A1
(43) Pub. Date: Sep. 12, 2002

(54) Apparatus and method for navigating electronic files using an array display

(76) Inventors: James G. Withers, Charlotte, NC (US); James P. Sizer, Kingwood, TX (US); Christopher J. Hart, Cincinnati, OH (US)

Correspondence Address: DOUGHERTY & CLEMENTS, TWO FAIRVIEW CENTER, 6230 FAIRVIEW ROAD, SUITE 400, CHARLOTTE, NC, 28210, US

(21) Appl. No.: 09/805,123

(22) Filed: Mar. 13, 2001

Related U.S. Application Data
(60) Provisional application No. 60/188,866, filed on Mar. 13, 2000.
(60) Provisional application No. 60/198,285, filed on Apr. 17, 2000.

(51) Int. Cl. G09G 5/00

(52) U.S. Cl. 345/773

(57) ABSTRACT

An end-user interface system for a computer, telephone or other electronic apparatus used to access the Internet or operating in standalone mode for navigating, displaying, and manipulating folders and files, web page links, and Internet bookmarks, such that each displayed folder, file, web page link, or Internet bookmark is displayed in a cell on a grid. To activate or further explore a particular file, an end-user activates a key on a computer keyboard or numeric keypad of a telephone or other electronic apparatus that corresponds to a particular option located within a cell on the grid. Hierarchical information such as file or folder structure, web site organization, or Internet bookmarks are arranged into the grid configuration. Use of the interface allows the manipulation of hierarchical data structures using a simple keypad having keys which correspond to the physical organization of the displayed grid, thus alleviating the need to use cumbersome or confusing point and click devices.

### CROSS-REFERENCE TO RELATED APPLICATION

This application claims the benefit of U.S. Provisional Application No. 60/188,866, filed Mar. 13, 2000.

### FIELD OF THE INVENTION

The present invention relates to a method and apparatus for organizing and manipulating computer or other electronic folders and files, Internet bookmarks, and Internet web page content. Said method is particularly useful for assisting end-users in navigating information structures in data servers.

### BACKGROUND OF THE INVENTION

It is essential to the operation of most computer, telephone, or other electronic equipment to allow for the storage, manipulation, and retrieval of electronic data and executable code, hereinafter collectively referred to as data. It is also essential to the operation of such equipment to have some type of informational structure which allows a user of the equipment to navigate a storage medium and locate stored data so that the data may be retrieved, altered, manipulated, executed, etc.

The actual physical placement and arrangement of data is typically unknown by a user. For instance, data may be stored on a hard drive, in electronic memory, or on a server located thousands of miles away. For the most part, an end-user need not be concerned with the technical details concerning how and where data is actually stored. Rather, the end-user is simply concerned with the ability to access previously stored data without any undue burden.

The physical placement of data is managed by a layer of software known as the operating system. The operating system catalogs the data available on a particular storage medium and presents a directory of such data to the user in a format which is easily understandable. Directories of data are presented as informational structures, the most common of which is a hierarchical tree. So, an end-user views all data stored by an electronic apparatus as a portion of the representative hierarchical tree presented by the operating system. Thereafter, actions taken by the user upon portions of the tree are translated into actual actions upon the physical data.

The hierarchical “tree” is described in terms of nodes, each node being a “root”, “branch”, or “leaf” of the tree. The beginning of the tree structure is often referred to as the root, although other names may be used. For example, Windows Explorer™ refers to the root as the desktop. The root can be thought of as a node that lacks an ancestor node, and therefore acts as a starting point of the hierarchical tree. It is sometimes convenient to think of major subsequent branch nodes as “roots”. For example, an Internet Service Provider's Home Page is conveniently thought of as a root node on the Internet even though several navigation steps are generally required to arrive at that node.

As mentioned above, the logical structure that the end-user traverses can generally be thought of as a tree. Each node offers the end-user the choice of n branches or links to a descendant node. Upon arrival at the descendant node, another set of choices are presented including retreating to the ancestor node in case the end-user wishes to undo a selection. The second node and all nodes that are deeper in the logical structure have ancestor nodes. Nodes are often named in order to create a mental image of an office. For example, from the desktop the end-user may select a folder, a name for the first descendent node. Folders may contain folders and so forth.

Staying with the tree analogy, the final destination may be thought of as a leaf, which is simply a node with no descendent in the external structure. A leaf may represent a data file or an executable program. Once a leaf is reached by the user, action upon the leaf will cause the data associated with the leaf to be executed, manipulated, etc. The depth of the informational structure, or tree, is defined as the number of nodes visited by the end-user en route to the leaf, m. If every node were fully populated with n descendent nodes and the end-user's leaf was m deep, the structure could contain up to n^{m} endpoints or leaves. Thus, a six-degree tree with a depth of four could permit the selection of 1296 endpoints.

U.S. Pat. No. 5,933,599 provides examples of a hierarchical tree navigation process. For example, FIG. 4 of the patent presents the Microsoft Explorer™ end-user interface. The root of the tree is called the desktop. In the illustration, the end-user has selected the nodes labeled My Computer, Drive C, and Papers. In the illustration, the node labeled Papers contains nodes labeled Documents and Letters and a leaf node labeled Notes.doc. The end-user is three nodes deep in the navigation process when the objective Notes.doc is selected. At this point, the end-user selects and acts upon the objective, here a document, for example by double left clicking it with a mouse.

When a computer system is attached to the Internet, the navigation process is typically similar to that of navigating a hierarchical file structure. For ease of use, web pages are manually or automatically grouped and categorized by source, subject matter, or some other common attribute so that a user may have some way in which to organize the millions of web pages currently posted on the Internet. When searching the Internet, the beginning node, or root, is called the Home Page. From a home page, the end-user may select a first descendant node, perhaps named Sports, and then a second descendant node, perhaps called Basketball, and so on. When the desired node is reached, the end-user may be presented with a list of articles (leaves in the hierarchical tree), perhaps articles concerning particular basketball teams.

Just as leaf nodes in a hierarchical file structure correspond to data in a storage medium, leaf nodes in a hierarchical Internet tree structure correspond to URL's, Uniform Resource Locators. Each URL is an address for a resource on the Internet. In the sports example above, a Web browser would typically hide the underlying URL's in order to maintain a familiar look and feel for the end-user. In the case of the Internet and its various variations, the penetration depth may be very great since there are perhaps 1,000,000 leaves. The navigation depth depends on the average degree at node. In the worst case, binary trees, the depth would be as high as 20 to reach 1,000,000 unique endpoints. If the degree averaged 6, the penetration depth would be 8.

There are several ways to circumvent the difficulties of navigating a complex framework such as the Internet. One is to assemble a personalized tree. From the home page, the end-user may manually assemble a “favorites list” or equivalent. Thus, the end-user may navigate a pre-prepared tree until success is achieved. For example, the user may select an NC State Wolfpack node and then “drop” the node into favorites list, which might reduce the navigation depth to 3 from 6 for the next time the end-user wishes to visit that particular node. Depending on the metaphor that the product wishes to evoke, the favorites list may be called a bookmark, etc.

A typical leaf on the Internet is an HTML, hypertext markup language, document. Such documents may contain hyperlinks which enable the end-user to navigate the tree laterally. For example, the end-user may be in a National Institutes for Health HTML document and contextually embedded in the document may be a description of The National Center for Advanced Illness Coordinated Care, followed by its URL, http://www.coordinatedcare.net. If the activities of this organization were relevant to the end-user, double left clicking the embedded URL would bypass the tree structure and send the end-user directly to a node representing the information controlled by this agency. To assist end-users in keeping track of which web pages a end-user has loaded/visited and which web pages the end-user might want to return to, the “Go Menu”, “History List”, “bookmarks”, and personal toolbar features have been added by most web browsers. These are metaphorical presentations that web browsers provide to reduce the navigation depth for the end user. Bookmarks may be stored on a personalized toolbar provided by some browsers, notably Netscape Navigator™ which is produced by Netscape.

Implementation of a hierarchical tree structure has three important ergonomic aspects: the cognitive paradigm or metaphor used to represent physical data, the visual representation of choices presented to the user, and the physical selection means for manipulating the structure. Generally, the desktop metaphor has been used to achieve reasonable ease of use. Guidance for providing reasonable ergonomics is provided in International Standards Organization Standard 9241, Ergonomic requirements for office work with visual display terminals (VDTs).

The visual representation can present the hierarchical tree metaphor, as shown in FIG. 3 (FIG. 4 in U.S. Pat. No. 5,933,599), which gives the end-user a graphical structure with sensibly named nodes. The dimensionality of a node may be expanded by using graphic sliders to scroll the screen up and down as if moving a window over a very high dimension structure.

The presentation of selection options is handled is a number of different but equivalent ways. Common examples include an array of “soft buttons” which are usually icons which may or may not be annotated. Example icons are shown in FIG. 3. My Computer annotates a line drawing of a computer and icons that are representational of disk drives are appropriately annotated. Each node is represented by a box with a “+” inside for an unselected node or a “−” for a selected node. FIG. 3 shows that nodes annotated My Computer, (C:), and Papers have been selected.

In a typical graphical user interface such as the one shown in FIG. 3, the end-user navigates the hierarchical tree by first moving a cursor that trails a pointing device being used, for example a mouse, to the box that represents the node being selected. Selection involves left-clicking the box if a mouse is used. Visual feedback is the fact that the “+” changes to a “−”. Other options may involve nested “pull-down” menus wherein the links available are presented as a vertical list of words, each representing a descendant node. When the end-user arrives at the desired leaf, the leaf is generally double left clicked and the file is opened.

The end-user mechanically effects the intended results by operating the attached pointing devices. A number of devices exist to accomplish this. The group includes but is not limited to: the mouse, isometric joysticks, isotonic joysticks, track balls, and touch pads. The most common device is the mouse, which has variations in button count and so forth. In some environments, manipulating a trailing cursor on the screen and pressing a button to indicate choice is also used. A stylus in the form of a light pen may be used. A touch-sensitive screen may be used and the end-user may point directly at the desired point on the screen with a stylus and activate a stylus-mounted button or ancillary button. Other interaction means are possible. For example, voice commands may be spoken into a microphone which evoke voice recognition software.

In a typical user interface, the end-user has “hotkey” alternatives to the point-and-click paradigm. For example, a set of action nodes at the top of a word processing page may be: File, Edit, View, Insert, Format, Tools, Window, Help. Rather than pointing and clicking, the end-user may “hotkey” a selection by simultaneously holding down the “Alt” key and the underscored letter to be selected. So, Alt-f is equivalent to positioning the trailing cursor on the word File and left clicking. Under File, there may be ten or more descendant nodes which are then activated by pressing a single underscored letter. These operations are repeated until the leaf level is reached.

To daily users of computer systems, traditional graphical end-user interfaces have become second nature. The analogy of nodes, roots, and leaves to files, folders, and desktops has enabled even novice computer users the ability to effectively search for and organize data. However, the mechanisms which make traditional graphical user interfaces so convenient for the majority of the population cause them to be unusable for others. In particular, the elderly user or the partially disabled user find traditional systems difficult to learn and difficult to use at both the cognitive and physical levels. Even daily users of computers may find traditional interfaces hard to use when distracted by other cognitive and physical activities such as driving a vehicle.

Any person who suffers from any disorder which causes trembling or deteriorated muscular control may find the fine positioning of a pointing device difficult. It is especially difficult to simultaneously hold the position of the trailing cursor and effect a “click” or “double-click”. Similarly, it is difficult for a person of diminished physical capacity to simultaneously actuate a series of keyboard keys as required by Alt-X type hotkey functions. Similarly, if a traditional computer user is required to perform an action such as driving a vehicle, the ability of such user to utilize these traditional methods of navigating the node, root, and leaf structure is severely reduced. Another case is simply when the traditional methods of navigating the node, root, and leaf structure are not available such as when using a cellular telephone where only a keypad exists.

Also, although the typical methods of presenting the hierarchical trees are useful and effective for seasoned and able users, the mere display of too many options can be confusing for the elderly, mentally infirm, or new user. In this way, layered menus, scroll bars, and multi-tiered displays do more to distract and confuse the computer user than to facilitate easy manipulation of an information structure.

What is needed is an alternative user interface for a computer, telephone or other electronic apparatus which allows easy and convenient navigation of hierarchical information structures while minimizing the amount of undesired information to the user. What is further needed is a user interface which facilitates ease of physical user interaction with the interface.

### SUMMARY OF THE INVENTION

The present invention is an end-user interface for use with a computer, telephone or other electronic apparatus. The invented interface enables a user to more easily traverse a hierarchical tree of information by displaying the tree, or portions of the tree, in a grid like format. The user then selects the desired descendant node or file to be explored or to be acted upon by actuating an input device having input components which directly correspond to the cells of the displayed grid. The interface is particularly suited for use with the numeric keypad found on typical computer keyboards or the numeric keypad found on touch tone and mobile telephones.

### OBJECTS OF THE INVENTION

The principal object of the present invention is to provide an ergonomically satisfactory end-user interface system for navigating structures to access the desired Internet destination or to access the desired destination in an off-line or local area network environment.

Another object of the invention is to provide a simple end-user interface system for use with computers, telephones, or other electronic apparatus for conveniently displaying and manipulating folders and files, web page links, and Internet bookmarks wherein the interface may be easily manipulated using a numeric keypad.

Another object of the invention is to provide an interface for manipulating a hierarchical data structure which is more easily used by the elderly or disabled who lack the physical or mental ability to accurately control a point and click device.

Another object of the invention is to provide a simplified interface for manipulating a hierarchical data structure which is suited for use while the user is otherwise distracted, such as while driving a vehicle.

### BRIEF DESCRIPTION OF THE DRAWINGS

The foregoing and other objects will become more readily apparent by referring to the following detailed description and the appended drawing in which:

FIG. 1 illustrates a calculator keypad layout according to prior art;

FIG. 2 illustrates a telephone keypad layout according to prior art;

FIG. 3 illustrates a conventional “point-and-click” data structure navigation system according to prior art;

FIG. 4 is a schematic of an hierarchical structure navigator using a calculator keypad layout according to this invention;

FIG. 5 is a schematic of an hierarchical structure navigator using a telephone keypad layout according to this invention;

FIG. 6 is a schematic of an example of navigation steps in accordance with the invention;

FIG. 7 is a schematic of a “favorites” substitution in accordance with this invention, and

FIG. 8 is a flow chart of the navigation set up process.

FIG. 9 is a diagram outlining the major components of the hardware usable with this invention.

### DETAILED DESCRIPTION

The present invention is an end-user interface for use with a computer, telephone or other electronic apparatus. The invented interface enables a user to more easily traverse a hierarchical tree of information by displaying the tree, or portions of the tree, in a grid like format. The user then selects the desired descendant node or file to be explored or to be acted upon by actuating an input device having input components which directly correspond to the cells of the displayed grid. The interface is particularly suited for use with the numeric keypad found on typical computer keyboards or the numeric keypad found on touch tone and mobile telephones.

In operation, the interface recognizes the hierarchical tree structure of data files configured by the operating system of a computer or the hierarchical tree structure of files supplied by an external source such as web pages supplied by the Internet. The invented interface then retrieves the information concerning the existing organizational structures and formats a representation of the organizational structure so that the structure may be represented by a grid. The number of cells in the grid is determined by the input method with which the interface is to be used. Typical input devices include, but are not limited to, a 3×3 numeric keypad on a standard computer keyboard or a 3×4 numeric keypad on a standard touchtone or mobile telephone.

Once the number of grid cells is determined, the components of the original organizational structure are categorized into the total number, or fewer, available cells. At any given time, the tree structure is viewed from the perspective of a particular node, hereinafter referred to as the active node. The active node simply denotes the node currently being manipulated or acted upon, and the active node may or may not have an antecedent node and may have any number of descendent nodes.

For instance, if a 3×3 display grid is chosen, then 9 cells would be available. If a particular location within the original organizational structure provided an active node having 15 descendent nodes, then the invented interface would re-categorize the 15 descendent nodes into 9 or fewer sections for display to the user. Criteria for re-categorizing original organizational structures may vary, depending upon the particular application, but the invented interface may search for common attributes among the original organizational structures so that they may be further organized into broader categories. For example, the interface may search for 6 pairs of commonalities among the descendent nodes, allowing the nodes to be displayed within a 9 cell grid. Alternatively, the interface may simply display the first 8 descendent nodes in the first 8 cells of the grid and reserve the 9^{th} cell for “remaining” nodes. Any method of grouping or categorizing nodes may be used by the invented interface.

Each cell of the interface grid corresponds to a key on a keyboard or keypad. The cells of the displayed grid may be identified by a number, letter, or brief identifier associated with the underlying node or nodes.

It is noted that the interface is not limited to the configuration of the telephone or computer keypad. Though the interface is preferably utilized with the computer or mobile phone numeric keypad, the interface is equally applicable for display and use with any physically corresponding key configuration. As an example, a 1×5 grid-like display may be used to correspond to the first five numbers along the top of the typical computer keyboard. Any such arrangement may be used while maintaining the physical correspondence between the layout of the grid-like display and the keys of the keypad or keyboard.

The user traverses the underlying hierarchical tree structure by actuating the keys on the numeric keypad which correspond to the desired grid cells, which in turn correspond to the node to be selected. The interface then analyzes the tree structure surrounding the selected node, which now becomes the active node, and displays another grid based upon the tree structure with respect to the active node. The manipulation process is repeated until the desired destination node is reached.

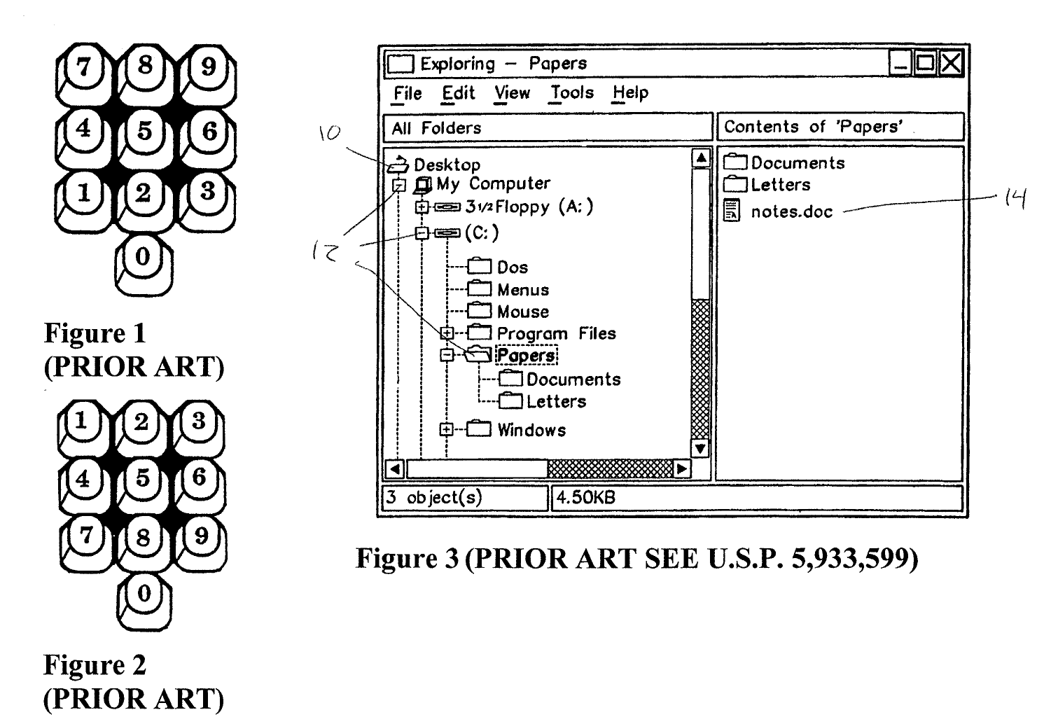

FIG. 1 illustrates a calculator layout of a numeric keypad. This is the common organization of keypads associated with a personal computer or terminal. Further characteristics of such a keypad may be found in ISO 9995. This is one of the structures that may be used to organize the available links to descendent nodes from any active node.

In a wireless environment, the layout illustrated in FIG. 2 is common and would commonly form the array-navigation structure in the wireless environment. It should be noted that environments with neither structure exist. For example, telecommunication devices for the deaf, TDDs, often use a keyboard with only four rows of keys rather than the base five row layout of ISO 9995. This is done for cost reasons and has historically been satisfactory for the deaf community. A terminal navigating the Internet from such a device would use a block of alphabetic keys to create a navigation pad using precisely the same method as illustrated here. All of the keypad arrangements exist in the prior art and are familiar to end-users in their respective environments, thereby avoiding the need for an end-user to become familiar with an additional input device in order to navigate a data structure. The ergonomic strength of the invented interface is the use of familiarity with input devices to simplify the physical and cognitive demands of the navigating system resources.

FIG. 3 illustrates the problems with typical off- line navigation according to prior art “point-and-click” methods. In the illustration, the root node 10 is called the desktop. The desktop 10 has several visible descendant nodes 12, including My computer. These descendant nodes 12 are not visible to the end-user unless the pointing device is used to slide the window down to these hidden nodes. Here the end-user has selected the descendent nodes 12 My computer, (C:), and Papers by using the pointing device. As illustrated, the folder Papers is the active node, with the descendent nodes shown in the graphical window on the right side of the display, and the non-leaf descendent nodes shown indented to the right under the Papers icon. Note that one leaf node 14, note.doc is visible in the Papers folder. It is common to find a mix of leaf nodes and nodes with descendants at any active node. A user of the typical navigation method manipulates the interface by “clicking” down through the network of descendent nodes 12 until the desired leaf node 14 is found. Internet Explorer™, a typical browser used to navigate the Internet, has the same look and feel of the illustrated off-line explorer. In the case of Internet Explorer™, the active node may be an Internet resource that is linked to descendent Internet resources.

The fact that a desired leaf node may be buried under or among literally thousands of other descendent nodes has necessitated the use of means for navigating directly from one node to another node within the hierarchical tree without the necessity of encountering every intermediate node. In this context, the beginning node, known as the anchor node, contains a leaf node or other information source containing directory information which identifies the particular location of the desired second node, known as the object node. In an off-line context, the anchor node is referred to as a shortcut. When used with browsers which navigate the Internet, the anchor node is referred to as a hyperlink, or simply link. Shortcuts and hyperlinks are important because they allow the user to reach frequently accessed leaf nodes, perhaps commonly used data files, applications, or Internet web pages, without the need to manually navigate through each intermediate descendent node located between the anchor node and the object node. In fact, users typically create a second hierarchical structure, hereinafter referred to as a secondary structure, containing only shortcuts or hyperlinks. In use, the second structure is navigated, a shortcut or hyperlink selection is made, the shortcut or hyperlink points to the location of the object node within the actual hierarchical tree, and the object node reached. Examples of secondary hierarchical structures are the “bookmarks” or “favorites” lists in typical Internet browsers and the “Start” menus of Microsoft Windows™ 95 and 98 software packages.

The invented interface greatly simplifies navigation of a hierarchical tree structure by displaying the structure, no matter how complicated, as a simple, easy to view grid. The tree is then manipulated by selecting the appropriate cells within the grid by using a keypad having keys which directly correspond to the physical location of the cells within the grid. The interface is equally adaptable for use in manipulating hierarchical data trees and secondary hierarchical structures.

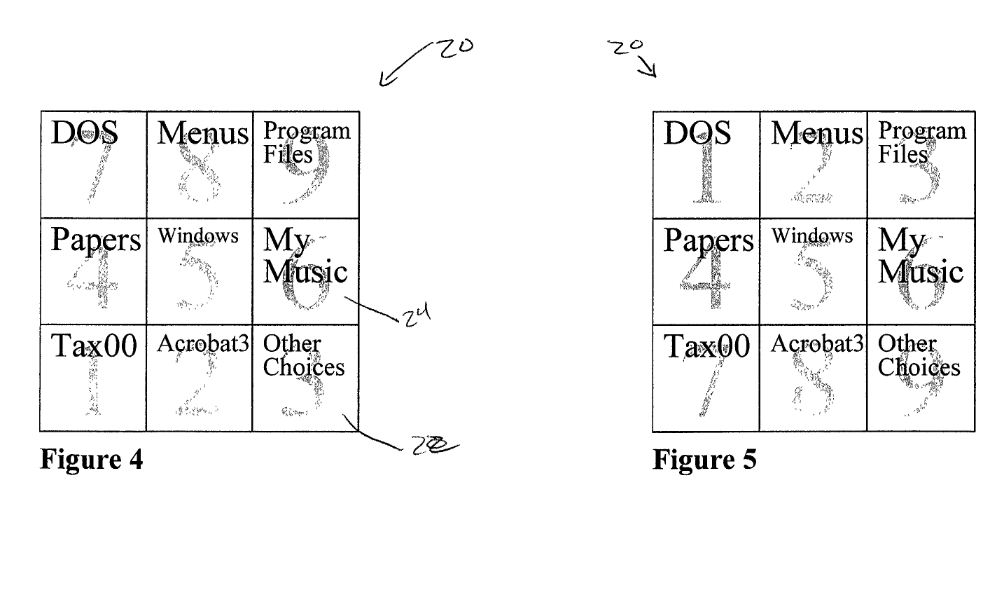

FIGS. 4 and 5 show an illustration of a display grid 20 produced by the invented interface as an example of this invention applied to the information structure displayed in FIG. 3. Assuming that the active node is (C:), FIG. 4 illustrates the invented interface display 20 configured to correspond to the keypad commonly located on personal computer keyboards. As shown, the descendent nodes of (C:) are each displayed within separate cells of a grid-like display, with one cell labeled “Other Choices” 22 indicating that there are more direct descendants of (C:) which may be viewed by selecting the cell containing the “Other Choices” 22 option. FIG. 5 shows a display 20 having the same hierarchical information shown in FIG. 4, but shows the information arranged in a configuration common to touch tone and wireless telephones. In both cases, the active node is (C:). The user navigates from the active node to any of the nodes corresponding to the nine possible selections by pressing the physical key on the keypad that corresponds to the number or position of the displayed cell within the displayed grid 20. The keypress, switches the active node to the corresponding descendent note, for example, My Music 24. If, for instance, the My Music 24 node were selected, then the descendent nodes of My Music 24 would be displayed within the grid 20 and the user would once again be presented with options. This procedure is continued until the user reaches the desired leaf node, which may then be selected and opened or activated.

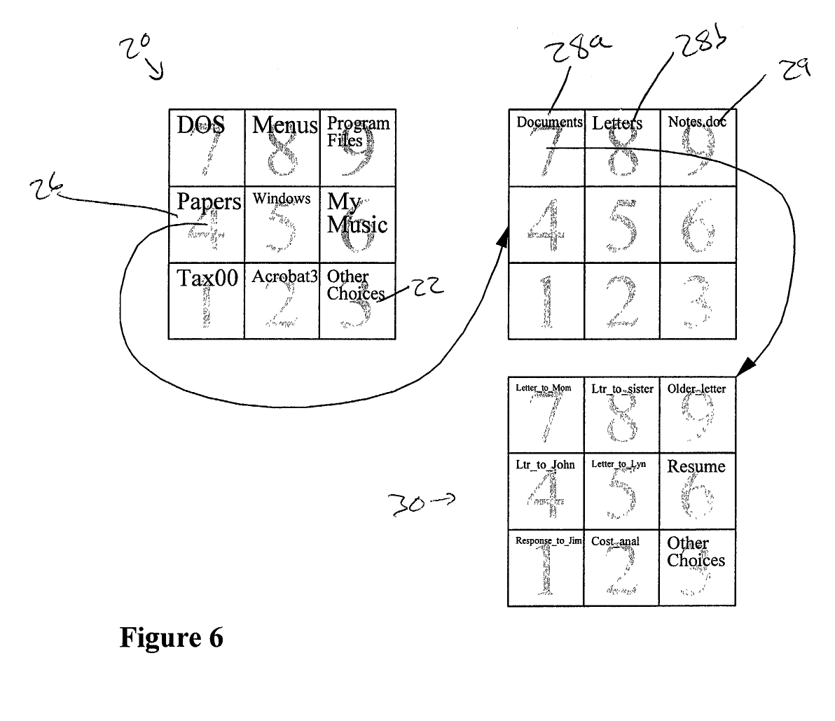

FIG. 6 demonstrates offline navigation of a hierarchical data structure using the invented interface starting with the active node (C:) of FIG. 4. As illustrated above, the interface displays the descendant nodes within a grid-like display 20 corresponding to the keys of a computer keypad. To examine the tree structure underneath the Papers 26 node, the user presses the physical key which corresponds to the middle left cell of the grid. Upon the keypress, the interface recognizes Papers 26 as the active node. In this example, Papers 26 is a node of degree three, containing two nodes 28 with descendants, labeled Documents 28a and Letters 28b and one leaf node 29, labeled Notes.doc. Repeating the process, the user selects the upper left key, which makes Documents 28a the active node and displays the descendant nodes 30 of the Documents node. As shown, there are more nodes 30 to be displayed than cells available, so the first eight nodes 30 are displayed and the last cell is simply labeled Other Choices 22 and allows the user to view the remaining descendant nodes 30. Once the final leaf node is reached, the data or application underlying the leaf node is retrieved or activated. The same structure and method applies to navigating the Internet. In the case of the Internet, the active node contains nine links, corresponding to the nine positions in the grid. Navigation is accomplished by pressing the keypad key in the corresponding physical position.

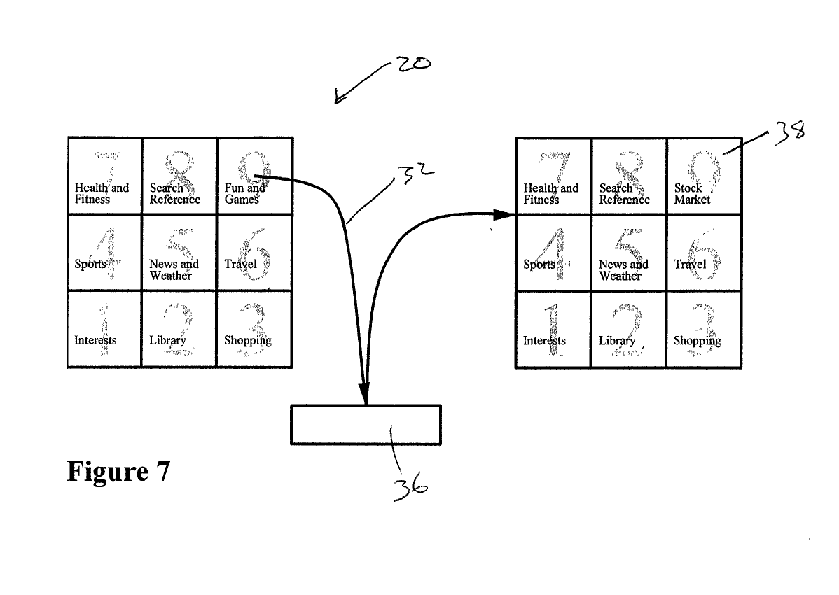

FIG. 7 shows a display 20 of the invented interface for navigating a secondary hierarchical structure with an Internet node. In this example, there are nine subject categories displayed within cells of a 9×9 grid. Using the same process as shown by FIG. 6, the secondary hierarchical structure is navigated until the desired link is reached. Upon activation of the link, the object node is retrieved or activated. When using the Internet, the object node would most likely be a web page to be viewed.

Referring again to FIG. 7, there are several ways the descendant nodes of a secondary structure may be organized. Preferably, the grid 20 is user customizable. For instance, the displayed grid 20 may be customized by using common drag and drop techniques, such as by dragging 32 Fun and Games 34 to a customize box 36, then selecting Stock Market 38 as the descendant node for grid position “9”. Alternatively, preexisting “favorites”, “bookmarks”, or “Go lists” may be automatically converted into a the grid format. Alternatively, sorting and grouping methods may be used to automatically group nodes containing common subject matter, so that grids may be automatically generated. Methods of automatically sorting Internet documents are known in the art and are exemplified by Pitkow et al., U.S. Pat. No. 6,038,574, incorporated herein by reference.

In addition to the grid 20 of links to descendant nodes, the interface may define ancillary keys to common functions such as “Next”, “Previous”, and “Home” which have as their descendant nodes, the next set of descendant nodes (when the degree of the active node exceeds nine), the just previous active node visited and the root node, respectively. For example, a wireless keypad usually has a lowest row of keys labeled “star”, “zero”, and “number sign”. These keys may be annotated with “Next”, “Previous”, and “Home”.

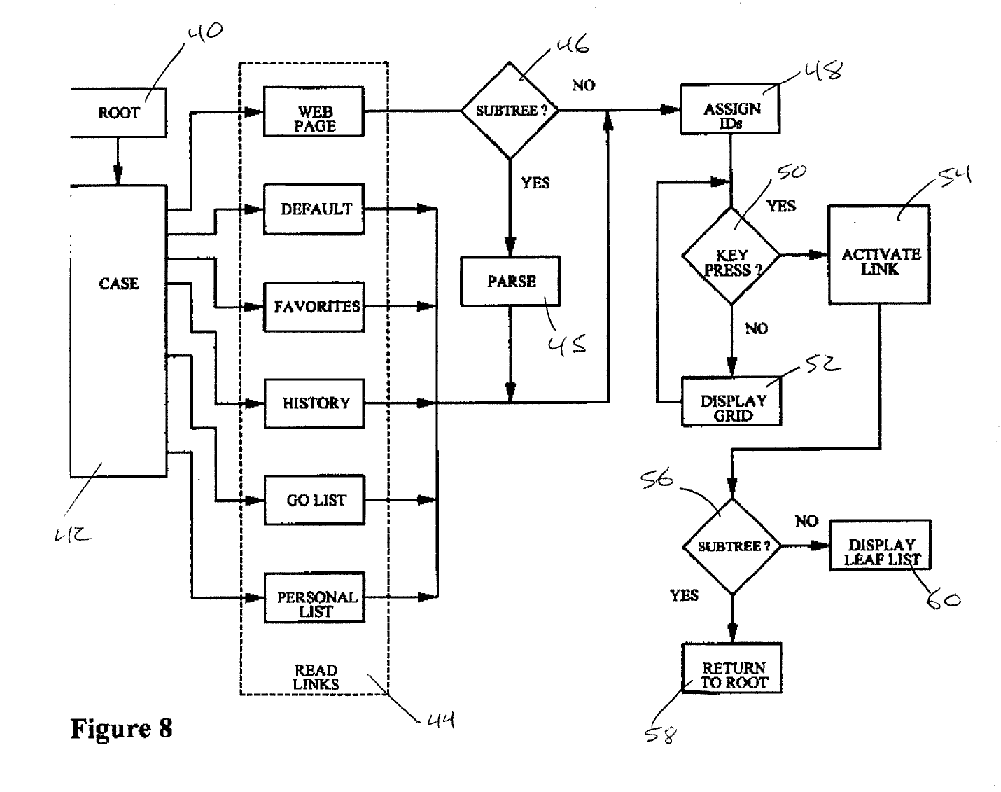

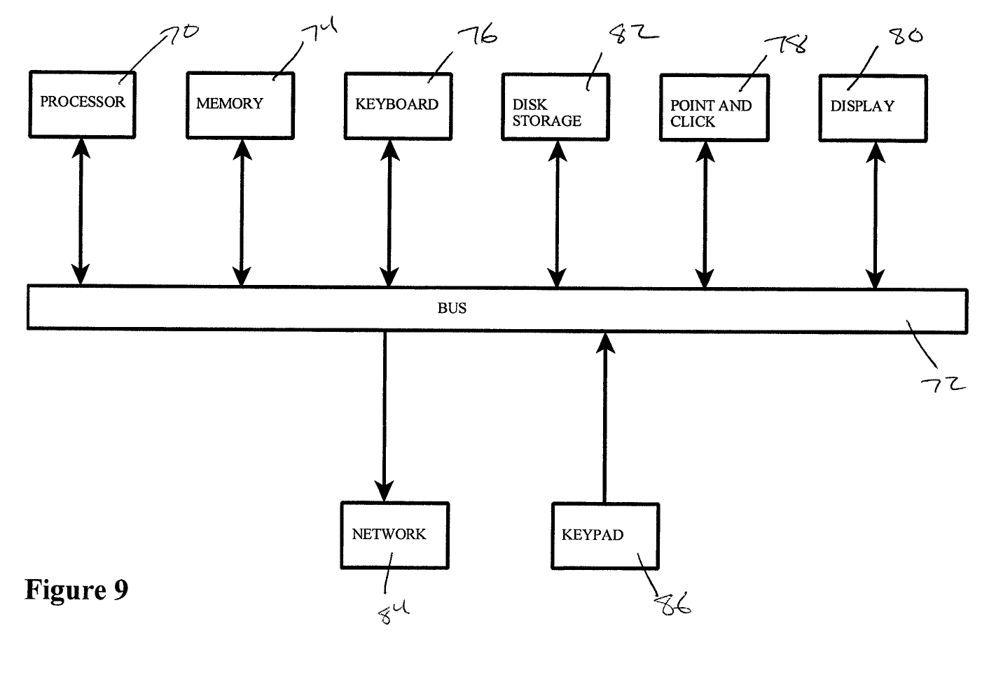

FIG. 8 shows a logical flow that is suitable for implementing the grid navigation system. The starting point is the root 40 of a navigation system or any node with descendants. The node 40 may be a subtree, that is a node that itself has at least one node with a descendant. Once the system arrives at an active node, the interface must find the appropriate table of descendants to populate the grid and activate the navigator. Associated with the root, or equivalent, is a decision variable for a CASE 42 statement. The table 44 with the needed data may be a web page, a default list, a favorites list, a history list, a go list, or a personal list that has been previously assembled by the user in a previous session. The CASE 42 decision provides a pointer to the location of the link and annotation data needed to fill in the grid 20 and arm the interface for the press of a key.

The interface has little trouble attaining the necessary file structure information when manipulating an off-line hierarchical file structure because the tree will already be arranged by the

We claim:

1. A method of navigating a hierarchical data structure comprising:
a) beginning at an active node;
b) referencing a table to determine the descendant nodes of the active node;
c) assigning identifiers to the descendant nodes;
d) displaying the identifiers in the cells of a grid-like display which cells correspond to the physical configuration of keys in a keypad;
e) accepting user input from the keypad which corresponds to a selected identifier;
f) designating the descendant node assigned to the selected identifier as the active node;
g) repeating steps b through f until the selected identifier is assigned to a leaf node; and,
h) activating the leaf node.

2. The method of claim 1, further comprising:
providing at least one function option, said function option being assigned an identifier and displayed in the grid, and said function option being enacted when the function option identifier becomes the selected identifier.

3. The method of claim 2, wherein the quantity of node identifiers requires display in multiple grid-like displays and wherein the function option is a toggle option allowing toggling between displays.

4. The method of claim 2, wherein the function option designates the most recent previous active node as the current active node when enacted.

5. The method of claim 2, wherein the function option designates a preselected node as the current active node when enacted.

6. The method of claim 1, wherein the table of descendant nodes is compiled by the operating system of a computer.

7. The method of claim 1, wherein the nodes are mark-up documents; and
further comprising:
a1) parsing the active mark-up document to extract links therefrom, said links corresponding to descendant nodes;
a2) determining the hierarchical structure of the links inherent in the active mark-up document coding; and,
a3) constructing a table of descendant nodes based upon the hierarchical structure of the extracted links.

8. The method of claim 1, wherein the active node is a mark-up document encoded with explicit hierarchical information; and
further comprising:
a1) extracting links from the active mark-up document;
a2) extracting the encoded hierarchical information from the active mark-up document;
a3) constructing a table of descendant nodes based upon the extracted links and extracted hierarchical information.

9. The method of claim 1, wherein the table is predefined.

10. The method of claim 1, wherein the grid-like display is selected from the group consisting of: a 3×3 grid and a 3×4 grid.

11. A system for navigating a hierarchical data structure comprising:
means for determining descendant nodes of a given active node;
a labeling means for labeling each descendant node;
a display means for displaying the labels associated with each descendant node in the cells of a grid-like display, said cells of the grid-like display corresponding to the physical location of keys in a keypad;
means for receiving user input in the form of actuation of a key from said keypad, said actuation corresponding to a selected label; and,
means for designating the node identified by the selected label as the active node and supplying said active node to the means for determining descendant nodes.

12. The system of claim 11, further comprising:
a node activation means for activating the node identified by the selected label if the node is a leaf node.

13. The system of claim 12, further comprising:
at least one function means, said function means having a label displayed in the grid-like display, and said function means providing that active node is selected from the group consisting of: the most recent previous active node that is an ancestor node, a predetermined node, and the most recent previous active node that is a descendant node.

14. The system of claim 12, further comprising:
a function means, said function means having a label displayed in the grid-like display, and said function means allowing the toggling between multiple grid-like displays.

15. The system of claim 12, wherein the means for determining descendant nodes accesses hierarchical information supplied by the operating system of a computer.

16. The system of claim 12, wherein the means for determining descendant nodes interprets implicit hierarchical information contained in a mark-up document.

17. The system of claim 12, wherein the means for determining descendant nodes interprets explicit hierarchical information contained in a mark-up document.

18. The system of claim 12, wherein the means for determining descendant nodes is predefined.

19. The system of claim 18, wherein the means for determining descendant nodes may be changed by a user.

20. The system of claim 12, wherein the grid-like display is selected from the group consisting of: a 3×3 grid and a 3×4 grid.
